(19) United States
(12) Patent Application Publication
(10) Pub. No.: US 2022/0161882 A1
(43) Pub. Date: May 26, 2022

(54) SMOKING APPARATUS

(71) Applicant: Paul Resta, Belle Harbor, NY (US)

(72) Inventor: Paul Resta, Belle Harbor, NY (US)

(21) Appl. No.: 17/102,862

(22) Filed: Nov. 24, 2020

(51) Int. Cl. B62J 11/16; B62J 50/00; A24F 3/00; A24F 7/00

(52) U.S. Cl. CPC B62J 11/16; A24F 7/00; A24F 3/00; B62J 50/00

(57) ABSTRACT

A smoking apparatus for attachment to a handlebar of a bicycle includes a smoking cartridge configured to couple to a first end portion of the handlebar, and an elongate hose configured to couple to a second end portion of the handlebar. Smoke generated in the smoking cartridge travels through the handlebar and into the elongate hose.

### TECHNICAL FIELD

This disclosure relates to a smoking apparatus, and more particularly to a smoking apparatus for use with a bicycle.

### BACKGROUND

The use of bicycles as a means of transportation is on the rise throughout the globe and especially in cities. Activities that would ordinarily be performed in a car while driving are commonly also performed while cycling. However, certain activities such as smoking may be difficult while on a bicycle either because it is difficult to store the materials required for smoking or it is challenging to perform the various steps of smoking while riding.

### SUMMARY

In one aspect, in accordance with the principles of the present disclosure, a smoking apparatus is provided for attachment to a handlebar of a bicycle. The smoking apparatus includes a first adapter configured to attach to a first end portion of a handlebar of a bicycle, a smoking cartridge configured to couple to the first adapter and for storing a smokable substance, and a hose assembly configured for slidable receipt in a second end portion of the handlebar. The hose assembly is configured to receive smoke from the smoking cartridge and to transfer the smoke out of the second end portion of the handlebar.

In aspects, the smoking cartridge may include a first head configured to couple to the first adapter, and a receptacle configured to couple to the first head. The receptacle may define a chamber therein configured for receipt of the smokable substance.

In aspects, the first adapter may have a threaded inner surface, and the first head may have a threaded outer surface configured for threaded engagement with the threaded inner surface of the first adapter.

In aspects, the first head may have a threaded inner surface, and the receptacle may have a threaded outer surface configured for threaded engagement with the threaded inner surface of the first head.

In aspects, the hose assembly may include an elongate hose and a second head. The elongate hose may have a first end portion, and a second end portion configured for slidable receipt in the second end portion of the handlebar. The elongate hose may define a passageway extending between the first and second end portions of the elongate hose. The second head may be configured to attach to the first end portion of the elongate hose. The second head may be configured to be in fluid communication with the passageway of the elongate hose.

In aspects, the smoking apparatus may further include a second adapter configured to attach to the second end portion of the handlebar. The second head of the hose assembly may be configured to couple to the second adapter.

In aspects, the second head may include a base portion configured for threaded engagement with the second adapter, and a mouthpiece extending from the base portion.

In aspects, the first adapter may be configured to surround and be fixedly secured to the first end portion of the handlebar, and the second adapter may be configured to surround and be fixedly secured to the second end portion of the handlebar.

In aspects, the hose assembly may include an elongate hose and a bushing. The elongate hose may have a first end portion and a second end portion. The elongate hose may define a passageway extending between the first and second end portions of the elongate hose. The bushing may be disposed about and coupled to the second end portion of the elongate hose to permit a slidable engagement of the elongate hose in the second end portion of the handlebar.

In accordance with another aspect of the present disclosure, a smoking apparatus for attachment to a handlebar of a bicycle is provided and includes a first adapter configured to attach to a first end portion of a handlebar of a bicycle, a second adapter configured to attach to a second end portion of the handlebar, and a smoking cartridge. The smoking cartridge includes a first head configured to couple to the first adapter and a receptacle configured to couple to the first head. The receptacle defines a chamber therein configured for receipt of a smokable substance.

In aspects, the smoking apparatus may further include a second head configured to couple to the second adapter.

In aspects, the smoking apparatus may further include an elongate hose having a first end portion configured to attach to the second head, and a second end portion configured for slidable receipt in the second end portion of the handlebar.

In aspects, the second head may include a base portion and a mouthpiece extending from the base portion. The base portion may be configured to attach to the first end portion of the elongate hose and the second adapter.

In aspects, the elongate hose may define a passageway extending between the first and second end portions thereof. The mouthpiece may be configured to be in fluid communication with the passageway.

In aspects, the first end portion of the elongate hose may be configured to detachably couple to the second adapter via the second head such that the elongate hose is configured to slide relative to the second adapter.

In aspects, the elongate hose may have a bushing disposed about the second end portion thereof. The bushing may be configured to permit slidable engagement of the elongate hose within the second end portion of the handlebar.

In accordance with another aspect of the present disclosure, a method of assembling a smoking apparatus to a handlebar of a bicycle is provided. The method includes securing a first adapter to a first end portion of a handlebar of a bicycle; securing a second adapter to a second end portion of the handlebar; attaching a smoking cartridge to the first adapter; and positioning an elongate hose in the second end portion of the handlebar such that the smoking cartridge and the elongate hose are in fluid communication with one another via the handlebar.

In aspects, positioning the elongate hose in the second end portion of the handlebar may include passing the elongate hose through the second adapter and coupling an end portion of the elongate hose to the second adapter.

In aspects, attaching the smoking cartridge to the first adapter may include positioning a receptacle of the smoking cartridge within the first adapter and coupling a head of the smoking cartridge to the first adapter.

As used herein, the terms parallel and perpendicular are understood to include relative configurations that are substantially parallel and substantially perpendicular up to about + or −15 degrees from true parallel and true perpendicular.

### BRIEF DESCRIPTION OF THE DRAWINGS

The present disclosure will become more readily apparent from the specific description accompanied by the following drawings, in which:

FIG. 1 is a perspective view illustrating an exemplary embodiment of a smoking apparatus assembled to a handlebar of a bicycle;

FIG. 2 is an exploded view illustrating the smoking apparatus of FIG. 1;

FIG. 3 is a perspective view illustrating a first adapter and a smoking cartridge of the smoking apparatus of FIG. 1 attached to a first end portion of the handlebar;

FIG. 4 is a side cross-sectional view illustrating the first adapter of the smoking apparatus of FIG. 3;

FIG. 5 is a side cross-sectional view illustrating a first head of the smoking cartridge of FIG. 3;

FIG. 6 is a side cross-sectional view illustrating a receptacle of the smoking cartridge of FIG. 3;

FIG. 7 is a perspective view illustrating a hose assembly of the smoking apparatus of FIG. 1 attached to a second end portion of the handlebar; and

FIG. 8 is a side cross-sectional view illustrating a second head of the hose assembly of FIG. 7.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “top” and “bottom” are relative and used only in the context to the other, and are not necessarily “superior” and “inferior.”

The present disclosure generally provides a smoking apparatus or assembly configured to be assembled to a handlebar of a bicycle. The smoking apparatus generally includes first and second adapters or collars configured for respective attachment to first and second end portions of the handlebar, a smoking cartridge, and a hose assembly. The smoking cartridge is configured to store a smoking substance (e.g., loose leaf tobacco) and to be detachably coupled to the first adapter. The hose assembly includes an elongate, hollow hose and a head attached to a first end portion of the hose. The head is configured to be detachably secured to the second adapter. The hose has a second end portion configured for slidable receipt in the second end portion of the handlebar.

In use, a user may slide the head of the hose assembly out of the second end portion of the handlebar and place the head of the hose assembly in the user's mouth. While inhaling through the head of the hose assembly, a flame may be directed at the smoking cartridge to ignite the smokable substance stored therein, whereby smoke generated in the smoking cartridge is drawn from the smoking cartridge, through a middle portion of the handlebar into the hose and out of the head of the hose assembly into the user's mouth. These and other advantageous of the presently disclosed smoking apparatus will be further elucidated herein.

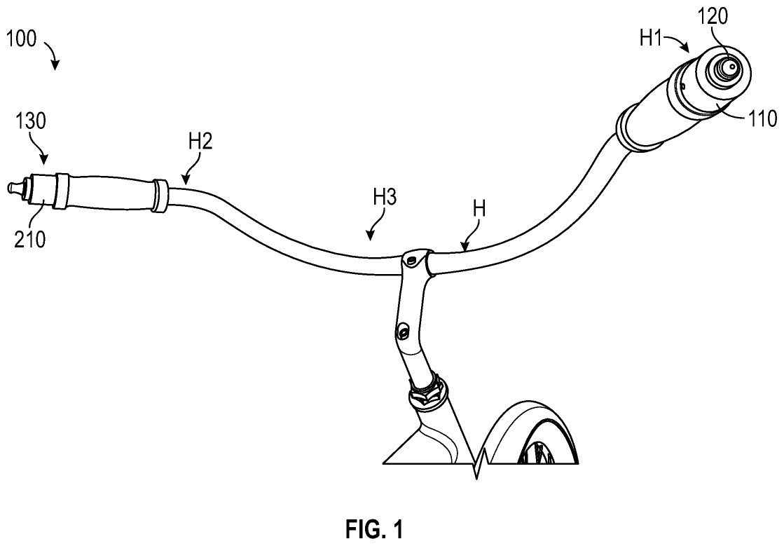

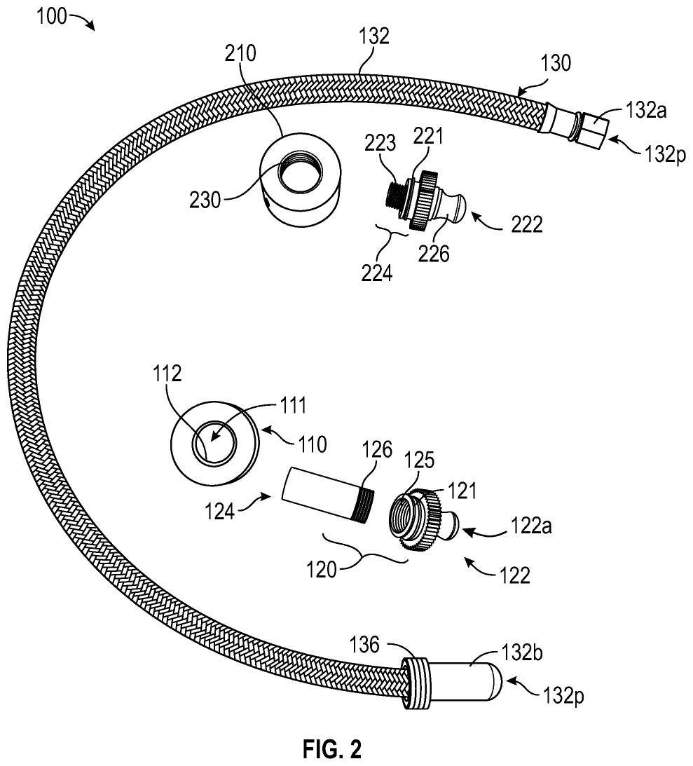

With reference to FIGS. 1 and 2, an exemplary smoking apparatus 100 for attachment to a handlebar “H” of a bicycle “B” is illustrated. In aspects, the smoking apparatus 100 may be configured for attachment to other suitable structures of a bicycle (e.g., a selected frame pipe with two openings) or other types of transportation means (e.g., a motorcycle). The smoking apparatus 100 is an assembly of parts and generally includes first and second adapters 110, 210, a smoking cartridge 120, and a hose assembly 130.

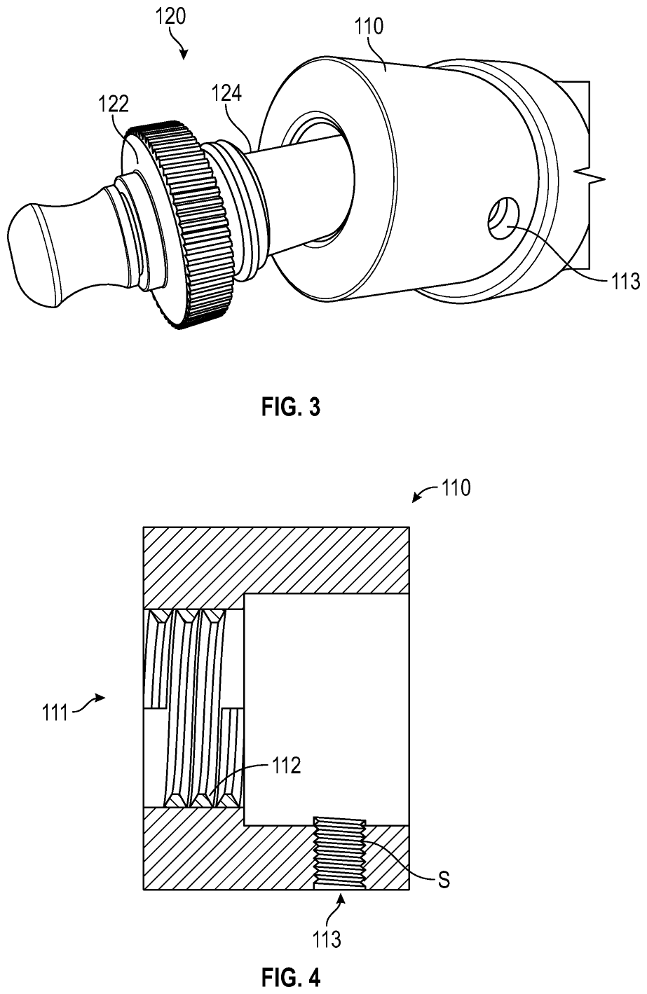

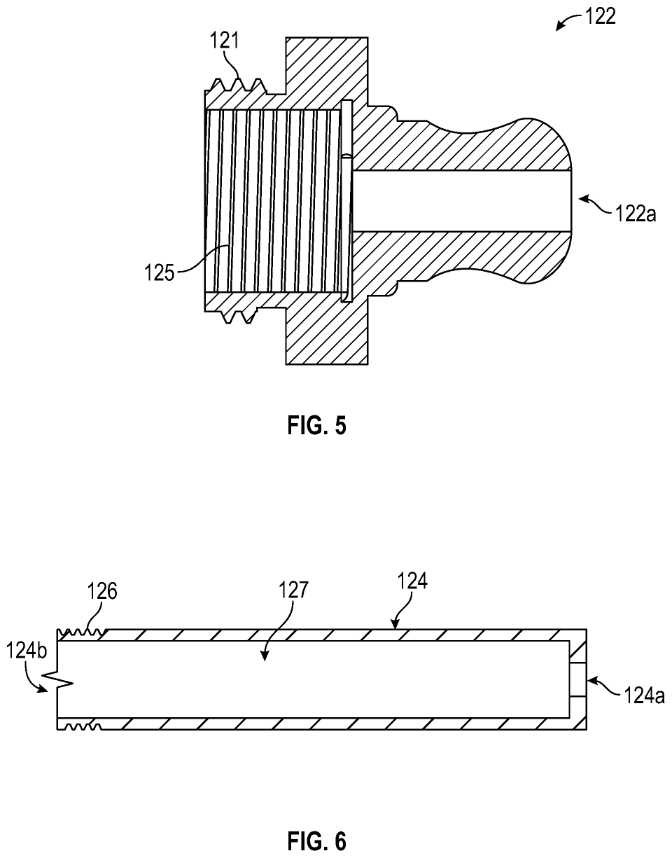

With reference to FIGS. 1-4, the first adapter 110 is configured to be attached to a first end portion “H1” of the handlebar “H” and the second adapter 210 is configured to be attached to a second end portion “H2” of the handlebar “H.” As will be described, the first adapter 110 detachably secures the smoking cartridge 120 to the first end portion “H1” of the handlebar “H” and the second adapter 210 detachably secures the hose assembly 130 to the second end portion “H2” of the handlebar “H.” The first adapter 110 is a cylindrical collar defining an opening 111 therethrough configured for receipt of the first end portion “H1” of the handlebar “H.” In aspects, the first adapter 110 may define other suitable shapes, such as, for example, rectangular. The first adapter 110 includes a threaded inner surface 112 configured for threaded engagement with a threaded portion 121 of the first head 122 of the smoking cartridge 120 (FIGS. 2, 5, and 6). The first adapter 110 is configured to securely fasten to the first end portion “H1” of the handlebar “H” by a set screw “S.” The set screw “S” is generally configured for threaded engagement and advancement through a side opening 113 defined laterally through the first adapter 110. In aspects, the first adapter 110 may be detachably secured to the first end portion “H1” of the handlebar “H” via other suitable fastening engagements, such as, for example, a friction-fit engagement, adhesives, a threaded engagement, or the like. The second adapter 210 (FIG. 2) may be substantially similar or identical to the first adapter 110 and is configured to surround and be fixedly secured to the second end portion “H2” of the handlebar “H.”

With reference to FIGS. 2, 3, 5, and 6, the smoking cartridge 120 of the smoking apparatus 100 includes a first head 122 and a receptacle 124 detachably connected to the first head 122. The first head 122 includes a threaded inner surface 125 configured to couple to a threaded outer surface 126 located at a top end 124b (FIG. 6) of the receptacle 124. In other aspects, first head 122 and the receptacle 124 may be monolithically formed with one another or permanently attached to one another. The first head 122 includes the threaded outer surface 121 configured to detachably connect to the threaded inner surface 112 of the first adapter 110. The receptacle 124 of the smoking cartridge 120 defines a chamber 127 therein configured for receipt of a smokable substance. The receptacle 124 defines a bottom opening 124a covered with a filter (not explicitly shown) that prevents the smokable substance from falling out of the receptacle 124 while permitting air to pass therethrough and into the first head 122 when the first head 122 is attached to the receptacle 124.

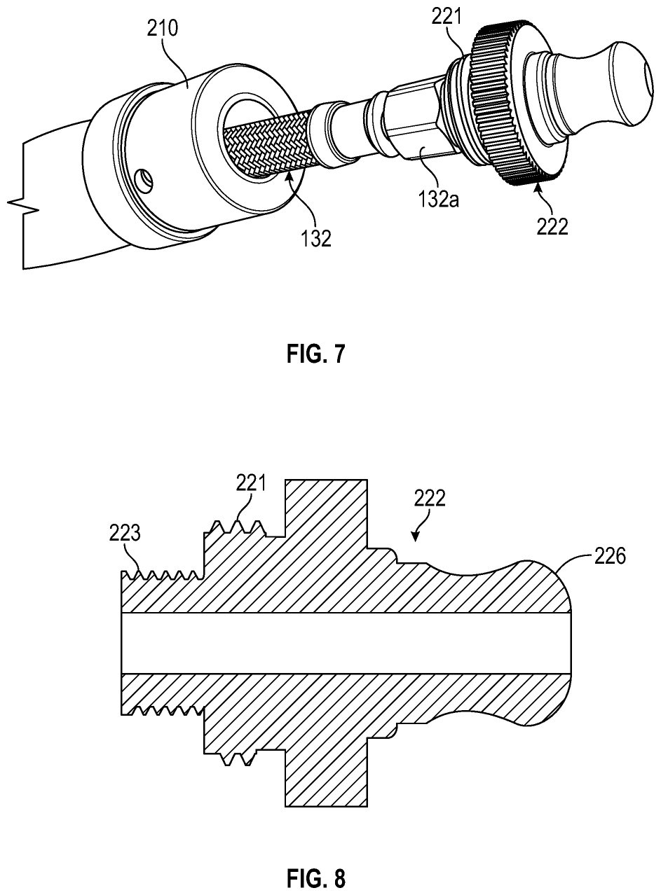

With reference to FIGS. 2, 7, and 8, the hose assembly 130 of the smoking apparatus 100 is configured for slidable receipt in the second end portion “H2” of the handlebar “H” and includes an elongate hose 132, a second head 222 detachably coupled to a first end portion 132a of the elongate hose 132, and a bushing 136 coupled to a second end portion 132b of the elongate hose 132. The elongate hose 132 may be a mesh sheath, a plastic tube, or any other suitable tube-like structure that defines a passageway 132p longitudinally therethrough. In aspects, the elongate hose 132 may be a telescoping hose.

The second head 222 of the hose assembly 130 is in fluid communication with the passageway 132p of the elongate hose 132 when the second head 222 is coupled to the elongate hose 132. The second head 222 includes a base portion 224 and a mouthpiece 226 extending from the base portion 224. The base portion 224 of the second head 222 has a first threaded outer surface 221 and a second threaded outer surface 223. The second threaded outer surface 223 of the base portion 224 is configured to detachably connect the second head 222 to the first end portion 132a of the elongate hose 132. In other aspects, the second head 222 may be permanently fixed to the elongate hose 132. The first threaded outer surface 221 of the base portion 224 of the second head 222 is configured to detachably couple to a threaded inner surface 230 of the second adapter 220.

The bushing 136 of the hose assembly 130 is disposed about and coupled to the second end portion 132b of the elongate hose 132. The bushing 136 is configured to permit a slidable receipt of the elongate hose 132 within the second end portion “H2” of the handlebar “H” while preventing smoke generated by the smoking cartridge 130 from passing through a gap defined between an outer surface of the elongate hose 132 and an inner surface of the second end portion “H2” of the handlebar “H.” The bushing 136 may be a rubber, fabric, or plastic gasket. Other types of configurations and materials are contemplated for the bushing 136.

To assemble the smoking apparatus 100 to a handlebar of a bicycle, such as the handle bar “H” of FIG. 1, the first and second adapters 110, 210 are secured to the respective first and second end portions “H1,” “H2” of the handlebar “H” by positioning the first and second adapters 110, 210 over the respective first and second end portions “H1,” “H2” and tightening the set screws “S” until the ends of the set screws “S” engage the outer surfaces of the first and second end portions “H1,” “H2” of the handlebar “H.” The smoking cartridge 120 may be attached to the first adapter 110 by inserting the receptacle 124 of the smoking cartridge 120 and the threaded portion 121 of the first head 122 of the smoking cartridge 120 through the opening 111 of the first adapter 110 and rotating the smoking cartridge 120 thereby connecting the first head 122 to the first adapter 110 via the threaded engagement between the threaded outer portion 121 of the first head 122 and the threaded inner surface 112 of the first adapter 110.

The second end portion 132b of the elongate hose 132 may be passed through the second adapter 210 and the second end portion “H2” of the handlebar “H” until the second head 222 of the hose assembly 130 engages the second adapter 210. Upon the second head 222 engaging the second adapter 210, the second head 222 is rotated to threadedly engage the second threaded outer surface 221 with the threaded inner surface 230 of the second adapter 210. It is contemplated that the second head 222 may be coupled to the first end portion 132a of the elongate hose 132 either before or after inserting the elongate hose 132 into the handlebar “H.” With each of the components of the smoking apparatus 100 assembled to the handlebar “H,” the first and second heads 122, 222 are in fluid communication with one another via the handlebar “H.”

To use the smoking apparatus 100, the smoking cartridge 120 may be detached from the first adapter 110 and the first head 122 of the smoking cartridge 120 may be detached from the receptacle 124 of the smoking cartridge 120. A smokable substance may be deposited in the chamber 127 of the receptacle 124 and the first head 122 may be re-attached to the receptacle 124. The assembled smoking cartridge 120 may then be attached to the first adapter 110. With the smoking cartridge 120 attached to the first end portion “H1” of the handlebar “H” via the first adapter 110, a user may detach the second head 222 of the hose assembly 130 from the second adapter 210 and pull the second head 222 along with the elongate hose 132 away from the second end portion “H2” of the handlebar “H” and place the mouthpiece 226 of the second head 222 in the user's mouth. While inhaling through the second head 222 of the hose assembly 130, a flame may be directed at an entrance opening 122a defined in the first head 122 of the smoking cartridge 120 to ignite the smokable substance stored therein. Smoke generated in the smoking cartridge 120 is drawn from the smoking cartridge 120, through a middle portion “H3” of the handlebar “H” into the elongate hose 132 and out of the mouthpiece 226 of the second head 222 of the hose assembly 130 into the user's mouth. It is contemplated that use of the smoking apparatus 100 may be performed while sitting on the bicycle with the bicycle either stopped or in motion or while standing next to the bicycle.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A smoking apparatus for attachment to a handlebar of a bicycle, the smoking apparatus comprising:
a first adapter configured to attach to a first end portion of a handlebar of a bicycle;
a smoking cartridge configured to couple to the first adapter and for storing a smokable substance; and
a hose assembly configured for slidable receipt in a second end portion of the handlebar and to receive smoke from the smoking cartridge and to transfer the smoke out of the second end portion of the handlebar.

2. The smoking apparatus according to claim 1, wherein the smoking cartridge includes:
a first head configured to couple to the first adapter; and
a receptacle configured to couple to the first head, the receptacle defining a chamber therein configured for receipt of the smokable substance.

3. The smoking apparatus according to claim 2, wherein the first adapter has a threaded inner surface, and the first head has a threaded outer surface configured for threaded engagement with the threaded inner surface of the first adapter.

4. The smoking apparatus according to claim 3, wherein the first head has a threaded inner surface, and the receptacle has a threaded outer surface configured for threaded engagement with the threaded inner surface of the first head.

5. The smoking apparatus according to claim 1, wherein the hose assembly includes:
an elongate hose having a first end portion, and a second end portion configured for slidable receipt in the second end portion of the handlebar, the elongate hose defining a passageway extending between the first and second end portions of the elongate hose; and
a second head configured to attach to the first end portion of the elongate hose, the second head configured to be in fluid communication with the passageway of the elongate hose.

6. The smoking apparatus according to claim 5, further comprising a second adapter configured to attach to the second end portion of the handlebar, wherein the second head of the hose assembly is configured to couple to the second adapter.

7. The smoking apparatus according to claim 6, wherein the second head includes a base portion configured for threaded engagement with the second adapter, and a mouthpiece extending from the base portion.

8. The smoking apparatus according to claim 6, wherein the first adapter is configured to surround and be fixedly secured to the first end portion of the handlebar, and the second adapter is configured to surround and be fixedly secured to the second end portion of the handlebar.

9. The smoking apparatus according to claim 1, wherein the hose assembly includes:
an elongate hose having a first end portion and a second end portion and defining a passageway extending between the first and second end portions of the elongate hose; and
a bushing disposed about and coupled to the second end portion of the elongate hose to permit a slidable engagement of the elongate hose in the second end portion of the handlebar.

10. A smoking apparatus for attachment to a handlebar of a bicycle, the smoking apparatus comprising:
a first adapter configured to attach to a first end portion of a handlebar of a bicycle;
a second adapter configured to attach to a second end portion of the handlebar; and
a smoking cartridge including:
a first head configured to couple to the first adapter; and
a receptacle configured to couple to the first head, the receptacle defining a chamber therein configured for receipt of a smokable substance.

11. The smoking apparatus according to claim 10, further comprising a second head configured to couple to the second adapter.

12. The smoking apparatus according to claim 11, further comprising an elongate hose having a first end portion configured to attach to the second head, and a second end portion configured for slidable receipt in the second end portion of the handlebar.

13. The smoking apparatus according to claim 12, wherein the second head includes:
a base portion configured to attach to the first end portion of the elongate hose and the second adapter; and
a mouthpiece extending from the base portion.

14. The smoking apparatus according to claim 13, wherein the elongate hose defines a passageway extending between the first and second end portions thereof, the mouthpiece configured to be in fluid communication with the passageway.

15. The smoking apparatus according to claim 12, wherein the first end portion of the elongate hose is configured to detachably couple to the second adapter via the second head such that the elongate hose is configured to slide relative to the second adapter.

16. The smoking apparatus according to claim 12, wherein the elongate hose has a bushing disposed about the second end portion thereof, the bushing configured to permit slidable engagement of the elongate hose within the second end portion of the handlebar.

17. The smoking apparatus according to claim 10, wherein the first adapter is configured to surround and be fixedly secured to the first end portion of the handlebar, and the second adapter is configured to surround and be fixedly secured to the second end portion of the handlebar.

18. A method of assembling a smoking apparatus to a handlebar of a bicycle, the method comprising:
securing a first adapter to a first end portion of a handlebar of a bicycle;
securing a second adapter to a second end portion of the handlebar;
attaching a smoking cartridge to the first adapter; and
positioning an elongate hose in the second end portion of the handlebar such that the smoking cartridge and the elongate hose are in fluid communication with one another via the handlebar.

19. The method according to claim 18, wherein positioning the elongate hose in the second end portion of the handlebar includes passing the elongate hose through the second adapter and coupling an end portion of the elongate hose to the second adapter.

20. The method according to claim 18, wherein attaching the smoking cartridge to the first adapter includes positioning a receptacle of the smoking cartridge within the first adapter and coupling a head of the smoking cartridge to the first adapter.
